(19) United States
(12) Patent Application Publication
(10) Pub. No.: US 2009/0208755 A1
(43) Pub. Date: Aug. 20, 2009

(54) THERMOPLASTIC TRANSPARENT COMPOSITION HAVING ABILITY TO ABSORB LIGHT WITH WAVELENGTH OF 410 NM AND MOLDED BODY THEREOF

(75) Inventors: Toshio Isozaki, Chiba (JP); Nobuyuki Kojima, Chiba (JP)

Correspondence Address: OBLON, SPIVAK, MCCLELLAND MAIER & NEUSTADT, P.C., 1940 DUKE STREET, ALEXANDRIA, VA, 22314, US

(73) Assignee: IDEMITSU KOSAN CO.,LTD., Chiyoda-ku (JP)

(21) Appl. No.: 11/816,447

(22) PCT Filed: Jan. 18, 2006
(86) PCT No.: PCT/JP2006/300592

§ 371 Date: Aug. 16, 2007

(30) Foreign Application Priority Data
Feb. 17, 2005 (JP) 2005-040992

(51) Int. Cl. C08K 5/09; C08G 18/44; B32B 27/32

(52) U.S. Cl. 428/412; 524/612; 524/287

(57) ABSTRACT

The present invention provides a thermoplastic transparent composition comprising: (A) 100 parts by mass of a transparent thermoplastic resin; and (B) 0.3 to 3.0 parts by mass of an ultraviolet absorber having an absorption band in the range at least of 340 to 410 nm, when determined in a chloroform solution, and also provides a molded article of the same. The thermoplastic transparent composition of the present invention has excellent transparency and shuts off light of 410 nm in wavelength. It can be widely used in the fields of optics, electrics, electronics, medical materials and others. For example, it can be formed into a lighting apparatus cover to provide a lighting apparatus having excellent mothproof property.

### TECHNICAL FIELD

The present invention relates to a transparent thermoplastic resin composition capable of blocking light having a particular wavelength and to a molded article of the same, more specifically, to a transparent thermoplastic resin composition that is utilized in the fields of optical, electric and electronic appliances and medical materials etc. and has the ability to absorb light of 410 nm in wavelength, and to a molded article of the same.

### BACKGROUND ART

Light of 410 nm in wavelength has noticeable photoinduction property for noxious inspects. If a material capable of blocking light of 410 nm in wavelength which is transparent and thermoplastic can be developed, it is applied to, for example, lighting apparatus covers, which can lead to lighting apparatuses having excellent mothproof property. Therefore, development of such materials has been awaited.

However, among known ultraviolet absorbers, there are almost no transparent resin compositions which have absorption in a wavelength band of 400 nm or higher. The transmission coefficient of some metal oxides such as TiO₂ in a wavelength band of 400 nm or higher can be controlled, but to ensure their light blocking properties sufficiently, their transparencies are sacrificed. Therefore, they cannot be used for the applications which require transparency. Moreover, some fluorescent whitening agents have absorption bands in the wavelength range of 400 nm or higher, but their performances deteriorate over time and molded articles thereof are not suitable for practical use.

In general, polycarbonate resins have excellent impact and heat resistances, and are widely used in various fields. However, the resins are somewhat problematic in terms of weathering resistance: undesired yellowish discoloration and other problems may occur when they are irradiated not only with normal solar source but also with light from high pressure mercury vapor lamps and metal halide lamps.

Therefore, resin compositions prepared by adding various photostabilizers singly or in combination to polycarbonate resins have been conventionally used and proposed.

For example, a polycarbonate resin composition prepared by adding an ultraviolet absorber comprising a benzotriazole compound and a fluorescent whitening agent selected from coumarin compounds and naphthalimide compounds to a polycarbonate resin is proposed (Patent document 1). Moreover, a polycarbonate resin composition prepared by adding an ultraviolet absorber comprising a triazine compound and a fluorescent whitening agent selected from coumarin compounds and naphthalimide compounds to a polycarbonate resin is also proposed (Patent document 2).

However, these proposed polycarbonate resin compositions still cannot be said to have sufficient weathering resistance, nor can shut off light of 410 nm in wavelength.

Moreover, demand for a thermoplastic resin composition having both transparency and weathering resistance has been increasing in recent years. An improvement in weathering resistance is intended by adding a fine powder of titanium oxide (TiO₂) or zinc oxide (ZnO) (Patent documents 3 and 4), but sufficient transparency has not been obtained. A film whose transparency is ensured by adding a fine powder of zinc oxide is proposed (Patent document 5). Moreover, a thermoplastic resin composition containing an ultraviolet absorber and a fine powder of titanium oxide or zinc oxide in a resin composition such as polycarbonate is proposed as a thermoplastic resin composition having both transparency and weathering resistance (Patent document 6).

As mentioned above, resin compositions comprising an ultraviolet absorber and a thermoplastic resin are already known, but no transparent resin composition which can effectively absorb and block light in the boundary region of the visible light region and the ultraviolet light region is known. As mentioned above, light of 410 nm in wavelength has noticeable photoinduction property for noxious inspects. If a transparent material capable of blocking light of 410 nm in wavelength is developed, it will be used widely in the fields of optics, electrics and electronics, medical materials and the like, for example, lighting apparatuses having excellent mothproof property and other products. Under such background, development of a material which shuts off light of 410 nm in wavelength is strongly desired.

[Patent document 1] Japanese Patent Application Publication No. H07-196904

[Patent document 2] Japanese Patent Application Publication No. H10-176103

[Patent document 3] Japanese Patent Application Publication No. H06-238829

[Patent document 4] Japanese Patent Application Publication No. H07-173303

[Patent document 5] Japanese Patent Application Publication No. 2000-309100

[Patent document 6] Japanese Patent Application Publication No. 2004-331679

### DISCLOSURE OF THE INVENTION

The present invention was made considering the circumstances described above. An object of the present invention is to provide a thermoplastic resin composition which has excellent transparency and the ability to shut off the light of 410 nm in wavelength and a molded article of the same.

The inventors of the present invention conducted extensive research to achieve the above object. As a result, they found that a thermoplastic transparent composition which has excellent transparency and the ability to shut off light of 410 nm in wavelength and a molded article of the same can be obtained by adding a specific amount of an ultraviolet absorber having a specific absorption band to a transparent thermoplastic resin such as polycarbonate. Herein, “to shut off light of 410 nm in wavelength” means to make a transmission coefficient of 410 nm-light 1% or lower in a molded article having a predetermined thickness. This is because sufficient mothproof property cannot be obtained if the transmission coefficient of 410 nm-light is higher than 1%. The present invention was accomplished on a basis of such findings.

That is, the present invention provides the following thermoplastic transparent compositions and molded articles of the same.
(1) A thermoplastic transparent composition comprising: (A) 100 parts by mass of a transparent thermoplastic resin; and (B) 0.3 to 3.0 parts by mass of an ultraviolet absorber having an absorption band in the range at least of 340 to 410 nm, when determined in a chloroform solution.
(2) The thermoplastic transparent composition as defined in (1), wherein the transparent thermoplastic resin is a polycarbonate resin.
(3) The thermoplastic transparent composition as defined in (1) or (2), wherein the ultraviolet absorber is a benzoate compound.
(4) The thermoplastic transparent composition as defined in any one of (1) to (3), wherein a transmission coefficient of light of 410 nm in wavelength is 1% or lower, and a haze value is 2% or lower in a molded article having a thickness of 0.8 mm.
(5) The thermoplastic transparent composition as defined in any one of (1) to (3), wherein a transmission coefficient of light of 410 nm in wavelength is 1% or lower, and a haze value is 2% or lower in a molded article having a thickness of 2 mm.
(6) A molded article formed by molding a thermoplastic transparent composition as defined in any one of (1) to (5), wherein the molded article blocks light of 410 nm in wavelength and has transparency.
(7) The molded article as defined in (6), wherein the molded article is formed by injection molding of a thermoplastic transparent composition as defined in any one of (1) to (5).
(8) A molded article of a laminated structure, wherein the molded article at least contains a molded article as defined in (6) or (7).
(9) The molded article as defined in (8), wherein the molded article is formed by co-extruding a thermoplastic transparent composition as defined in any one of (1) to (5) and another transparent thermoplastic resin.
(10) The molded article as defined in (8), wherein the molded article is formed by extruding a thermoplastic transparent composition as defined in any one of (1) to (5) and another transparent thermoplastic resin separately to form molded articles, and bonding the obtained separate molded articles together.
(11) The molded article as defined in any one of (6) to (10), for use in applications of lighting apparatus covers, sunglass lenses, photoresists, transparent office automation equipment, housings for electric or electronic appliances, and medical instruments.

### EMBODIMENTS FOR CARRYING OUT THE INVENTION

Examples of the transparent thermoplastic resin of the component (A) in the present invention include polycarbonate resins, polyolefin resins such as polyethylene, polypropylene and polybutylene, polyvinyl chloride resins, polyvinylidene chloride resins, polyvinyl acetate resins, polyvinyl alcohol resins, chlorinated polyethylene resins, ethylene-α-olefin copolymers, propylene-α-olefin copolymers, ethylene-vinyl chloride copolymers, ethylene-vinyl acetate copolymers, ethylene tetrafluoride-ethylene copolymers, ethylene tetrafluoride-propylene hexafluoride copolymers, vinyl polyfluoride resins, polyvinylidene difluoride resins, transparent polyamide resins, polyethylene terephthalate resins, polyethylene naphthalate resins and the like. These may be used singly or in combination of two or more kinds. In the present invention, polycarbonate resins are preferred in terms of obtaining a molded article having good transparency.

As the above-mentioned polycarbonate resins, their chemical structures and production methods are not particularly limited and various substances can be used. For example, aromatic polycarbonate resins produced by a reaction between a divalent phenol and a carbonate precursor can be suitably used.

Various substances can be used as the above-mentioned divalent phenol. Suitable examples include 2,2-bis(4-hydroxyphenyl)propane, bis(4-hydroxyphenyl)methane, 1,1-bis(4-hydroxyphenyl)ethane, 2,2-bis(4-hydroxy-3,5-dimethylphenyl )propane, 4,4′-dihydroxydiphenyl, 1,1-bis(4-hydroxyphenyl)cyclohexane, bis(4-hydroxyphenyl)ether, bis(4-hydroxyphenyl )sulfide, bis(4-hydroxyphenyl)sulfone, bis(4-hydroxyphenyl)sulfoxide, bis(4-hydroxyphenyl)ketone, hydroquinone, resorcin, catechol and the like. Among these divalent phenols, bis(hydroxyphenyl)alkane, in particular 2,2-bis(4-hydroxyphenyl)propane [bisphenol A] is preferred. These divalent phenols may be used singly or in combination of two or more kinds.

Moreover, carbonate precursors usable for a reaction with a divalent phenol are carbonyl halides, carbonyl esters, or haloformates and the like. More specifically, phosgene, dihaloformates of divalent phenols, diphenyl carbonates, dimethyl carbonates and diethyl carbonates can be used.

The chemical structure of this polycarbonate resin can be such that its molecular chain has a linear structure, a cyclic structure or a branched structure. Among these, suitable examples of polycarbonate resins having a branched structure include those produced by using, as a branching agent, 1,1,1 -tris(4-hydroxyphenyl)ethane, α,α′,α″-tris(4-hydroxyphenyl)-1,3,5-triisopropylbenzene, phloroglucin, trimellitic acid, isatinbis(o-cresol) and the like. Moreover, as this polycarbonate resin, polyester-carbonate resins produced by using bifunctional carboxylic acids such as terephthalic acid or their ester precursors such as ester forming derivatives can be also used. Furthermore, mixtures of these polycarbonate resins having various chemical structures can be also used.

The viscosity average molecular weight of these polycarbonate resins is normally 10,000 to 50,000, preferably 13,000 to 35,000, more preferably 15,000 to 25,000. This viscosity average molecular weight (Mv) is a value obtained by determining the viscosity of a methylene chloride solution at 20° C. by using an Ubbelohde viscometer, determining an intrinsic viscosity [η] from this measurement and calculated by the equation of [η]=1.23×10⁻⁵ Mv.^{0.83}

For such adjustment of the molecular weight of a polycarbonate resin, phenol, p-tert-butylphenol, p-dodecylphenol, p-tert-octylphenol, p-cumylphenol and the like are used.

As this polycarbonate resin, polycarbonate-polyorganosiloxane copolymers can be further used. This copolymer can be prepared by, for example, dissolving polycarbonate oligomer and polyorganosiloxane having a terminal reactive group in a solvent such as methylene chloride, adding an aqueous solution of divalent phenol in sodium hydroxide to this solution, and causing an interface polycondensation reaction by using a catalyst such as triethylamine. As a polyorganosiloxane structure portion in this case, that having polydimethyl siloxane structure, polydiethyl siloxane structure, polymethylphenyl siloxane structure, polydiphenyl siloxane structure is suitably used.

Moreover, this polycarbonate-polyorganosiloxane copolymer used is suitably such that the degree of polymerization of the polycarbonate portion is 3 to 100 and the degree of polymerization of the polyorganosiloxane portion is approximately 2 to 500. Moreover, the amount of the polyorganosiloxane portion contained in this polycarbonate-polyorganosiloxane copolymer is suitably 0.5 to 30% by mass, preferably 0.5 to 20% by mass. Furthermore, the viscosity average molecular weight of this polycarbonate-polyorganosiloxane copolymer is 10,000 to 50,000, preferably 13,000 to 35,000, and more preferably 15,000 to 25,000.

The ultraviolet absorber of the component (B) used in the present invention has an absorption band in the range of at least 340 to 410 nm, when determined in a chloroform solution. The phrase “to have an absorption band in the range at least of 340 to 410 nm” means that an absorbance determined by a spectrophotometer (calculated from the strength of a transmission light relative to incident light) falls within the range of the absorption band. Examples of such ultraviolet absorbers include benzophenone-based compounds, benzotriazole-based compounds, benzoate compounds, cyanoacrylate-based compounds and the like, among which benzotriazole-based compounds and benzoate compounds are more preferable, and in particular benzoate compounds are preferable. The amount added is 0.3 to 3.0 parts by mass, preferably 0.5 to 2.5 parts by mass, more preferably 1.0 to 2.0 parts by mass relative to 100 parts by mass of the transparent thermoplastic resin. A resin composition having a good absorptivity for light of 410 nm in wavelength can be obtained by adding 0.3 to 3.0 parts by mass of an ultraviolet absorber having an absorption band in the range at least of 340 to 410 nm.

Specific examples of benzophenone-based compounds used as the above-mentioned ultraviolet absorber include 2-hydroxy-4-n-octoxybenzophenone, 2-hydroxy-4-methoxy-benzophenone, 2-hydroxy-4-ethoxy-benzophenone and the like.

Moreover, specific examples of the above-mentioned benzotriazole-based compound include 2-(2′-hydroxy-5′-tert-octylphenyl)benzotriazole, 2-(2′-hydroxy-3′,5′-di-tert-amylphenyl)benzotriazole, 2-(2′-hydroxy-5′-tert-butylphenyl)benzotriazole, 2-(2′-hydroxy-3′,5′-di-tert-butylphenyl)benzotriazole, 2-[2′-hydroxy-3′,5′-bis(α,α-dimethylbenzyl)phenyl]-2H-benzotriazole, 2,2′-methylene-bis[4-methyl6-(benzotriazole-2-yl)phenol] and the like.

Specific example of the above-mentioned benzoate compound include diethylamino hydroxybenzoyl hexyl benzoate, methylethylamino hydroxybenzoyl hexyl benzoate, dimethylamino hydroxybenzoyl hexyl benzoate, ethylpropylamino hydroxybenzoyl hexyl benzoate, dipropylamino hydroxybenzoyl hexyl benzoate and the like.

Specific examples of the above-mentioned cyanoacrylate-based compounds include 2-ethyl-2-cyano-3,3-diphenyl acrylate, 2-ethylhexyl-2-cyano-3,3-diphenyl acrylate,

1,3-bis-[2′-cyano-3,3′-diphenylacryloyloxy]-2,2-bis-[(2-cyano-3′,3′-diphenylacryloyl)oxy] methylpropane and the like.

In the present invention, a compound obtained by graft-polymerizing an ultraviolet-absorbing unit on an acrylic polymer can be also used as the ultraviolet absorber of the component (B). This compound has a structure in which an ultraviolet-absorbing unit having an ultraviolet absorptivity is introduced into a polymer chain of the acrylic polymer by graft polymerization (hereafter referred to as “high-molecular ultraviolet absorber”). Examples of acrylic monomer constituting this acrylic polymer include acrylic acid, methacrylic acid, alkyl acrylate esters, alkyl methacrylate esters, acrylamide, methacrylamide, copolymerized polymers of these acrylic monomers and copolymerizable vinyl compounds having a double bond and the like. Examples of this copolymerizable vinyl compounds include alkyl vinyl ethers such as methyl vinyl ether and ethyl vinyl ether; vinyl acetate, alkyl vinyl esters such as ethylvinyl and 2-ethylhexylvinyl; styrene, maleic anhydride and the like. The number average molecular weights of these acrylic polymers are 20,000 to 200,000, and preferably 50,000 to 200,000.

An ultraviolet-absorbing unit introduced into this acrylic polymer may be any compound that has an ultraviolet absorptivity. Examples include the aforementioned benzophenone-based compounds, benzotriazole-based compounds, cyanoacrylate-based compounds, benzoate compounds and the like. These compounds are introduced into polymer chains of acrylic polymers by graft polymerization. In this case, the amount of the ultraviolet-absorbing unit introduced into the acrylic polymer is 40 to 90% by mass, preferably 50 to 80% by mass of the total mass of the ultraviolet absorber.

Preferable high-molecular ultraviolet absorbers are those in which the ultraviolet-absorbing unit is a benzotriazole compound or a benzoate compound, especially a benzoate compound, and the number average molecular weight of the acrylic polymer is 50,000 to 200,000. The high-molecular ultraviolet absorbers may be used singly or in combination of two or more kinds, and can be also used in combination with the aforementioned ultraviolet absorbers.

If necessary, a stabilizer (antioxidant, dispersing agent, etc.), mold releasing agent, coloring agent (dye, pigment) and other additives can be added to the thermoplastic resin composition of the present invention in a range which does not adversely affect the effect of the present invention. Examples of antioxidants include phenol-based antioxidants such as pentaerythrityl-tetrakis[3-(3,5-di-t-butyl-4-hydroxyphenyl )propionate]; phosphorus-based antioxidants such as phosphite esters and tris(2,4-di-t-butylphenyl)phosphite; and sulfur-based antioxidants such as dilauryl-3,3′-thiodipropionate. Examples of dispersing agents include magnesium stearate and the like. Examples of mold releasing agents include monoglycerin stearate, polyethylene tetrastearate and the like. The antioxidant and mold releasing agent may contain a radical scavenger and an acid neutralizer. As a coloring agent, a generally used pigment or the like is used. The amount of these additives added is preferably 1 part by mass or less based on 100 parts by mass of the thermoplastic resin composition.

Regarding the method of producing the thermoplastic transparent composition of the present invention, if necessary, the above additives may be added to the above components (A) and (B) in an amount suitable for required characteristics of a molded article and kneaded. Blenders and kneaders used herein are those normally used. For example, a ribbon blender, drum tumbler and the like can be used to carry out pre-mix, and a Henschel mixer, Banbury mixer, single screw extruder, twin screw extruder, multiple screw extruder, Ko-kneader or the like may be used. The heating temperature in kneading is normally selected from the range from 240 to 300° C. suitably. For this fusion kneading molding, an extrusion molder, in particular a vented extrusion molder is preferably used. The components other than the thermoplastic resin contained can be fused and kneaded with the thermoplastic resin in advance, that is, can be added as a master batch.

The thermoplastic resin composition of the present invention can be used as a raw material in the form of a kneaded product obtained by the above-mentioned fusion kneading molding or pellets to produce various kinds of molded articles by injection molding, injection-compression molding, extrusion molding, blow molding, press molding, foam molding or other methods. In this case, especially preferable is the method of fusing and kneading the components mentioned above to produce a pelletized molding raw material, and then producing injection molded articles by injection molding or injection-compression molding with these pellets. Moreover, employing the gas injection molding as this injection molding can give a molded article which has no sink mark but has excellent appearance and reduced weight.

By forming the thermoplastic transparent composition of the present invention, a molded article capable of blocking light of 410 nm in wavelength and having transparency, for example, a molded article in which a transmission coefficient of light of 410 nm in wavelength is 1.0% or lower and a haze value is 2% or lower in a molded article having a thickness of 0.8 mm, or a molded article in which a transmission coefficient of light of 410 nm in wavelength is 1% or lower and a haze value is 2% or lower in a molded article having a thickness of 2 mm can be obtained.

Moreover, a molded article with a laminated structure can be obtained by co-extruding the thermoplastic resin composition of the present invention and another transparent thermoplastic resin. A molded article with a laminated structure can be also obtained by extruding the thermoplastic resin composition of the present invention and another transparent thermoplastic resin separately to form molded articles, and bonding the obtained separate molded articles together.

A molded article using the obtained thermoplastic transparent composition of the present invention can be widely used in the fields of optics, electrics and electronics, medical materials, for example, for lighting apparatus covers, sunglass lenses, photoresists, transparent office automation equipment, housings for electric or electronic appliances and various medical materials.

### EXAMPLES

The present invention is now described in more details with reference to Examples, but the present invention is not limited to these Examples.

Evaluation of performance was carried out by the measurement methods described below.
Initial haze value (%); Measurement was conducted by using a full-automatic direct-reading haze computer HGM-2DP (light source C) manufactured by Suga Test Instruments Co., Ltd. according to JIS K7105.
Spectral transmission factor: A 10-μg/ml chloroform solution was prepared. A spectral transmission factor of 350 to 700 nm was determined by using a recording spectrophotometer UV-2400PCS manufactured by Shimadzu Corporation.

### Examples 1 to 6 and Comparative Examples 1 to 8

(B) Ultraviolet absorbers were added to (A) 100 parts by mass of a polycarbonate resin (PC-A2200 manufactured by Idemitsu Kosan Co., Ltd.) in the formulation amounts shown in Table 1, and the mixtures were fused and kneaded by a 50-mm single shaft extruder (NVC50) at 280° C. and pelletized. Injection molding was performed by a 440KN injection molding machine (IS45PV manufactured by Toshiba Machine Co., Ltd.) using pellets to obtain test pieces (30 mm×40 mm×2 mm) and test pieces (30 mm×40 mm×0.8 mm). The evaluation results of the optical properties of the test pieces determined in the manner described above are shown in Table 1.

The (B) ultraviolet absorbers used in Table 1 are as follows:
B-0: diethylamino hydroxybenzoyl hexyl benzoate (Yupinal A, Plus manufactured by BASF Japan Ltd., absorption band: 250 to 410 nm)
B-1: 2-(2′-hydroxy-5′-tert-octylphenyl) benzotriazole (Kemisorb79 manufactured by Chemipro Kasei Kaisha, Ltd., absorption band: 260 to 400 nm)
B-2: 2-(4,6-diphenyl-1,3,5-triazine-2-yl)-5-(hexyl )oxyphenol (Tinuvin 1577 manufactured by Ciba Specialty Chemicals K.K., absorption band: 240 to 400 nm)
B-3: 2,2′-(1,4-phenylene)bis(4H-3,1-benzoxazine) (UV-3638 manufactured by Cytec Company Ltd., absorption band: 270 to 390 nm)

TABLE 1

| | Example 1 | Ex. 2 | Ex. 3 | Ex. 4 | Ex. 5 | Ex. 6 |
|---|---|---|---|---|---|---|
| Amount of UV absorber contained | | | | | | |
| (Part by mass/100 parts by mass of PC) | | | | | | |
| B-0: Absorption band: 250 to 410 nm | 0.5 | 1.0 | 1.5 | 2.0 | 2.5 | 3.0 |
| Evaluation of optical characteristics | | | | | | |
| (Thickness of molded article: 2 mm) | | | | | | |
| Initial haze value (%) | 1.0 | 1.2 | 1.6 | 2.2 | 2.8 | 3.3 |
| Spectrum transmission factor at 410 nm (%) | 0.5 | 0.4 | 0.5 | <0.01 | <0.01 | <0.01 |
| (Thickness of molded article: 0.8 mm) | | | | | | |
| Initial haze value (%) | 0.8 | 0.9 | 1.0 | 1.2 | 1.6 | 1.9 |
| Spectrum transmission factor at 410 nm (%) | 2 | 1.5 | 1.0 | 0.8 | 0.5 | 0.3 |

| | Comparative | Comp. | Comp. | Comp. | Comp. | Comp. | Comp. | Comp. |
|---|---|---|---|---|---|---|---|---|
| | example 1 | Ex 2 | Ex 3 | Ex 4 | Ex 5 | Ex 6 | Ex 7 | Ex 8 |
| Amount of UV absorber contained | | | | | | | | |
| (Part by mass/100 parts by mass of PC | | | | | | | | |
| B-0: Absorption band: 250 to 410 nm | 0.1 | 3.5 | | | | | | |
| B-1: 260 to 400 nm | | | 2.5 | 3.0 | | | | |
| B-2: 240 to 400 nm | | | | | 2.5 | 3.0 | | |
| B-3: 270 to 390 nm | | | | | | | 2.5 | 3.0 |
| Evaluation of optical characteristics | | | | | | | | |
| (Thickness of molded article: 2 mm) | | | | | | | | |
| Initial haze value (%) | 0.8 | | 1.6 | 2.2 | 1.9 | 2.6 | 1.9 | 2.7 |
| Spectrum transmission factor at 410 nm (%) | 2.2 | | 89.8 | 88.7 | 89.1 | 87.8 | 88.4 | 82.4 |
| (Thickness of molded article: 0.8 mm) | | | | | | | | |
| Initial haze value (%) | | 2.3 | | | | | | |
| Spectrum transmission factor at 410 nm (%) | | 0.3 | | | | | | |

Table 1 reveals the followings:
(1) In the thermoplastic transparent composition of the present invention, a molded article having a thickness of 0.8 mm has a transmission coefficient of 1% or lower and a haze value is 2% or lower for light of 410 nm in wavelength, or a molded article having a thickness of 2 mm has a transmission coefficient of 1% or lower and a haze value of 2% or lower for light of 410 nm in wavelength (Examples 1 to 6).
(2) When the amount of the ultraviolet absorber having an absorption band at 340 to 410 nm in the thermoplastic transparent composition of the present invention is too low, the transmission coefficient of light of 410 nm in wavelength becomes high, while the haze value is worsened when the amount is too high (Comparative Examples 1 to 2).
(3) When an ultraviolet absorber having no absorption band at 340 to 410 nm is used, the transmission coefficient of light of 410 nm in wavelength becomes high (Comparative Examples 3 to 8).

### INDUSTRIAL APPLICABILITY

According to the present invention, a thermoplastic transparent composition which has excellent absorptivity of light of 410 nm in wavelength and a molded article of the same can be provided by adding a specific amount of an ultraviolet absorber having a specific absorption band to a transparent thermoplastic resin such as polycarbonate.

The thermoplastic transparent composition of the present invention can be widely used in the fields of optics, electrics, electronics, medical materials and others. For example, it can be formed into a lighting apparatus cover to provide a lighting apparatus having excellent mothproof property.

1. A thermoplastic transparent composition comprising: (A) 100 parts by mass of a transparent thermoplastic resin; and (B) 0.3 to 3.0 parts by mass of an ultraviolet absorber having an absorption band in the range at least of 340 to 410 nm, when determined in a chloroform solution.

2. The thermoplastic transparent composition as defined in claim 1, wherein the transparent thermoplastic resin is a polycarbonate resin.

3. The thermoplastic transparent composition as defined in claim 1, wherein the ultraviolet absorber is a benzoate compound.

4. The thermoplastic transparent composition as defined claim 1, wherein a transmission coefficient of light of 410 nm in wavelength is 1% or lower and a haze value is 2% or lower in a molded article having a thickness of 0.8 mm.

5. The thermoplastic transparent composition as defined in claim 1, wherein a transmission coefficient of light of 410 nm in wavelength is 1% or lower and a haze value is 2% or lower in a molded article having a thickness of 2 mm.

6. A molded article formed by forming a thermoplastic transparent composition as defined in claim 1, wherein the molded article blocks light of 410 nm in wavelength and has transparency.

7. The molded article as defined in claim 6, wherein the molded article is formed by injection molding of the thermoplastic transparent composition.

8. A molded article of a laminated structure, wherein the molded article comprises at least one a molded article as defined in claim 6.

9. The molded article as defined in claim 8, wherein the molded article is formed by co-extruding the thermoplastic transparent composition and another transparent thermoplastic resin.

10. The molded article as defined in claim 8, wherein the molded article is formed by extruding the thermoplastic transparent composition and another transparent thermoplastic resin separately to form molded articles, and bonding the obtained separate molded articles together.

11. (canceled)

12. A method of preparing an article comprising inserting the molded article of claim 6 into the article, wherein said article is lighting apparatus covers, sunglass lenses, photoresists, transparent office automation equipment, housings for electric or electronic appliances, or medical instruments.
